(19) United States
(12) Patent Application Publication
(10) Pub. No.: US 2006/0159473 A1
(43) Pub. Date: Jul. 20, 2006

(54) Device and method for adjusting the detected amount of remaining toner

(75) Inventors: Hyung-Jin An, Suwon-si (KR); Jae-Min Kwon, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/294,437

(22) Filed: Dec. 6, 2005

(30) Foreign Application Priority Data
Jan. 20, 2005 (KR) 2005-0005405

(51) Int. Cl. G03G 15/08

(52) U.S. Cl. 399/27

(57) ABSTRACT

A device and method to adjust the amount of remaining toner is provided. The device includes first through n-th light emitting units, each of which emits light. The device also includes first through n-th toner agitating units which are respectively formed in first through n-th cell of a toner cartridge and respectively reflect the light emitted from the first through n-th light emitting units. Next, the device includes, first through n-th light receiving units which receive the light reflected by the first through n-th toner agitating units, respectively. The device further includes a toner remaining amount adjusting unit which adjusts a detected amount of remaining toner according to the light receiving results of the first through n-th light receiving units.

### CROSS-REFERENCE TO RELATED PATENT APPLICATIONS

This application claims the benefit under 35 U.S.C. § 119(a) of Korean Patent Application No. 10-2005-0005405, filed on Jan. 20, 2005, the entire disclosure of which is hereby incorporated by reference.

### BACKGROUND OF THE INVENTION

1. Field of the Invention

The present invention relates to an image forming apparatus. More particularly, the present invention relates to a device and method for adjusting an amount of toner remaining in an image forming apparatus so that a user can accurately determine the amount of toner remaining.

2. Description of the Related Art

Generally, toner is used as an image forming agent in an image forming apparatus. As an image is formed, the toner is gradually consumed. Therefore, the image forming apparatus includes a device which detects the amount of consumed toner. Conventional methods which measure the amount of remaining toner are generally classified into two types. The first method uses a photo sensor. A photodetecting unit and a light-emitting unit of the photo sensor are installed on both sides of a toner cartridge.

When the cartridge is filled with toner, light does not pass through the cartridge. Alternatively, when the toner is exhausted, light passes through the cartridge and the photo sensor is operational. Using this method, the user typically cannot determine the amount of toner consumed, but, only the time when the developer should be replaced.

The second method is a dot count method. In this method, the amount of remaining toner is calculated by analyzing a laser signal sent to the developer from a laser scanning unit (LSU). The time of scanning the laser signal is relatively proportional to the amount of consumed toner.

Additionally, the amount of remaining toner may be measured by adding an experimentally obtained compensation variable. However, since the amount of toner consumed for processing the same input signal changes according to the environments where the image forming apparatus is used, the conventional method in which the amount of consumed toner is inversely calculated from the input signal has limited accuracy and precision.

Another method in which the sensor is directly installed on the toner cartridge can immediately and accurately measure the amount of consumed toner; however, this method does not measure continuously.

FIG. 1 is a graph illustrating errors that occur when the amount of remaining toner is detected using the conventional dot count method. As shown in FIG. 1, if the amount of remaining toner is detected to be smaller at \textcircled{2} than the actual amount at \textcircled{1}, a message informing a user that the toner should be changed may be generated prematurely. In addition, if the amount of remaining toner is detected to be more \textcircled{3} than the actual amount at \textcircled{1}, a user may believe that enough toner is available even when the actual amount of remaining toner is not sufficient for printing.

Accordingly, there is a need for a device which adjusts the detected amount of remaining toner so that a user can continuously and accurately determine the amount of remaining toner by combining signals successively obtained by a sensor and/or a dot count method.

### SUMMARY OF THE INVENTION

An aspect of the present invention is to address at least the above problems and/or disadvantages and to provide at least the advantages described below. Accordingly, an aspect of the present invention is to provide a device which adjusts the detected amount of remaining toner so that a user can be continuously and accurately informed of the amount of remaining toner by combining signals successively obtained by a sensor and information about the amount of remaining toner successively obtained using a dot count method. According to an aspect of the present invention, there is provided a device for adjusting the detected amount of remaining toner. The device comprises first through n-th (‘n’ represents an integer which is larger than 1) light emitting units, each of which emits light. Additionally, the device includes, first through n-th toner agitating units which are respectively formed in first through n-th cell of a toner cartridge and respectively reflect the light emitted from the first through n-th light emitting units. Next, the device includes, first through n-th light receiving units which receive the light reflected by the first through n-th toner agitating units, respectively. The device further includes a toner remaining amount adjusting unit which adjusts a detected amount of remaining toner according to the light receiving results of the first through n-th light receiving units.

According to another aspect of the present invention, there is provided a method of adjusting the detected amount of remaining toner. The method comprises the steps of detecting the amount of remaining toner, checking whether a k-th (‘k’ represents a natural number that is larger than 1 and not more than ‘n’ which is a natural number larger than 1) light receiving unit of first through n-th light receiving units receives light, adjusting the detected amount of remaining toner according to the light receiving result of the k-th light receiving unit when the k-th receiving unit receives light, and checking whether all the first through n-th light receiving units receive light.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a graph which illustrates errors that occur when the amount of remaining toner is detected using a conventional dot count method;

FIG. 2 is a block diagram of a device which adjusts the detected amount of remaining toner according to an embodiment of the present invention;

FIG. 3 is a view which explains in detail a first toner agitating unit illustrated in FIG. 2;

FIG. 4 is a block diagram illustrating a toner remaining amount adjusting unit illustrated in FIG. 2 according to an embodiment of the present invention;

FIG. 5 is a graph illustrating errors that occur when the amount of remaining toner is adjusted;

FIG. 6 is a flowchart illustrating a method of adjusting the amount of remaining toner according to an embodiment of the present invention; and

FIG. 7 is a flowchart illustrating operation 304 illustrated in FIG. 6.

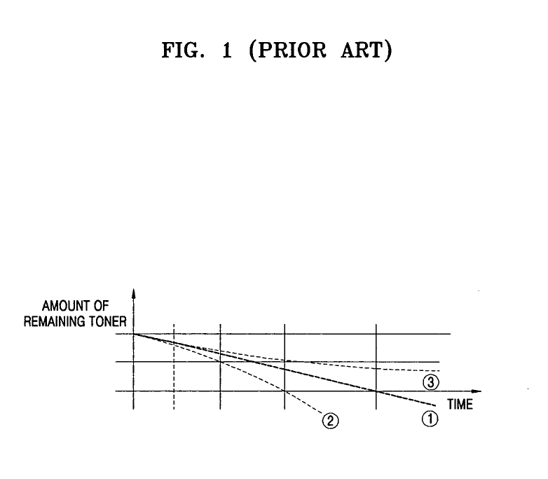

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

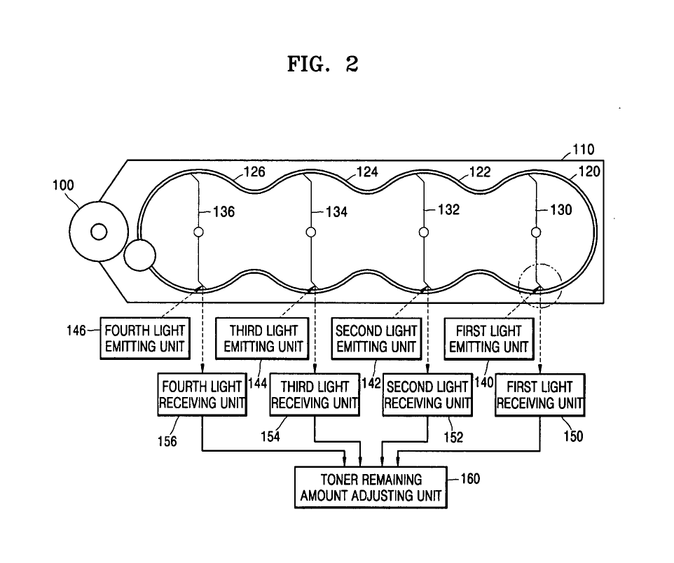

FIG. 2 is a block diagram of a device for adjusting the amount of remaining toner according to an embodiment of the present invention. Referring to FIG. 2, the device includes a developing roller 100, a toner cartridge 110, a first cell 120, a second cell 122, a third cell 124, and a fourth cell 126. Additionally, the device includes a first toner agitating unit 130, a second agitating unit 132, a third agitating unit 134, a fourth agitating unit 136, a first light-emitting unit 140, a second light-emitting unit 142, a third light-emitting unit 144, a fourth light-emitting unit 146, and a first photodetecting unit 150. Further, the device includes a second photodetecting unit 152, a third photodetecting unit 154, a fourth photodetecting unit 156, and a toner remaining amount adjusting unit 160.

The developing roller 100 is supplied with toner stored in the toner cartridge 110 and develops an image.

The toner cartridge 110 includes the first to fourth cells 120, 122, 124, and 126 to store toner.

The toner cartridge 110 is made of a suitable material through which light reflected by the first to fourth toner agitating units 130, 132, 134, and 136 can pass.

The first to fourth cells 120, 122, 124, and 126 are included in the toner cartridge 110 to supply the toner sequentially to the developing roller 100. That is, the toner contained in the first cell 120 is transferred to the second cell 122, the toner originally contained in the second cell 122 is transferred to the third cell 124, the toner originally contained in the third cell 124 is transferred to the fourth cell 126, and the toner originally contained in the fourth cell 124 is finally supplied to the developing roller 100. The first to fourth cells 120, 122, 124, and 126 are made of suitable materials through which light reflected by the first to fourth toner agitating units 130, 132, 134, and 136 can pass.

The first to fourth toner agitating units 130, 132, 134, and 136 are included in the first to fourth cells 120, 122, 124, and 126, respectively. The first to fourth toner agitating units 130, 132, 134, and 136 pass the toner to the developing roller 100.

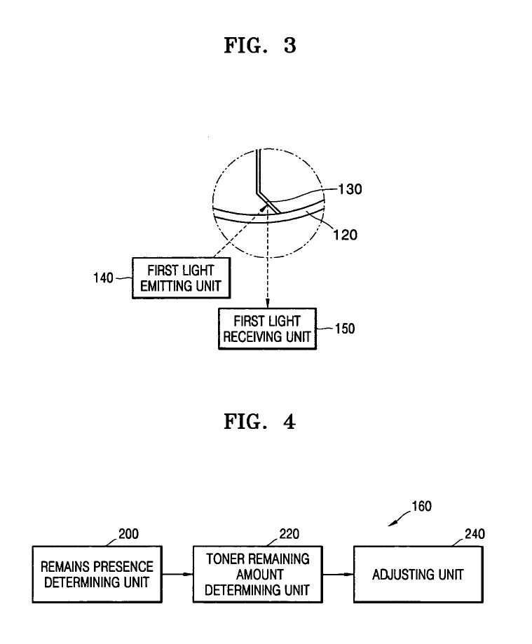

FIG. 3 is a view illustrating the first toner agitating unit 130 illustrated in FIG. 2. Referring to FIG. 3, the first toner agitating unit 130 is disposed closely and adjacent to the first cell 120 and passes the toner stored in the first cell 120 to the second cell 122. At this time, a curved portion of the first toner agitating unit 130 receives and reflects light emitted from a first light-emitting unit 140, and outputs the reflected light to a first light receiving unit 150.

The first through fourth toner agitating units 130, 132, 134, and 136 reflects light respectively emitted from first through fourth light emitting units which will be described below. The first through fourth toner agitating units 130, 132, 134, and 136 can reflect the light emitted from the first through fourth light emitting units 140, 142, 144, and 146, respectively, when the toner is consumed in each of the first through fourth cells 120, 122, 124, and 126. This is because, when the toner remains in the first to fourth cells 120, 122, 124, and 126, the first through fourth toner agitating units 130, 132, 134, and 136 cannot receive the light emitted from the first through fourth light emitting units 140, 142, 144, and 146 due to the remaining toner.

The first to fourth toner agitating units 130, 132, 134, and 136 are composed of materials to reflect the light beams emitted from the first through fourth light emitting units 140, 142, 144, and 146. In particular, the first through fourth toner agitating units 130, 132, 134, and 136 are made of material such as polyethylene film or polyethylene terephthalate film. The light beams reflected from the first through fourth toner agitating units 130, 132, 134, and 136 are output to the first through fourth light receiving units 150, 152, 154, and 156, respectively.

The first through fourth light emitting units 140, 142, 144, and 146 emit light beams to the first through fourth toner agitating units 130, 132, 134, and 136, respectively. Each of the first through fourth light emitting units 140, 142, 144, and 146 uses a light emitting diode (LED) to emit the light. The LED is a semiconductor element which emits light by flowing currents to a compound such as GalliumArsenic (GaAs).

The first through fourth light receiving units 150, 152, 154, and 156 receive the light beams reflected from the first through fourth toner agitating units 130, 132, 134, and 136, respectively. Each of the first through fourth light emitting units 150, 152, 154, and 156 uses a light receiving diode. The light receiving diode is a semiconductor diode that converts an optical signal to an electrical signal. A photodiode may be used as the light receiving diode. In the photodiode, when a p-n junction is reversely biased and illuminated by light, generated electrons and holes move in an electric field of the p-n junction and thus a photocurrent flows. At this time, an output voltage almost proportional to the intensity of the light is generated. Each of the first through fourth light receiving units 150, 152, 154, and 156 outputs the light receiving result to the toner remaining amount adjusting unit 160.

The toner remaining amount adjusting unit 160 adjusts a detected amount of remaining toner based on the light receiving result from the first through fourth light receiving units 150, 152, 154, and 156. The amount of remaining toner is detected using a dot count method.

Each time when the toner remaining amount adjusting unit 160 receives the light receiving result from one of the first to fourth light receiving units 150, 152, 154, and 156, the toner remaining amount adjusting unit 160 adjusts the amount of remaining toner.

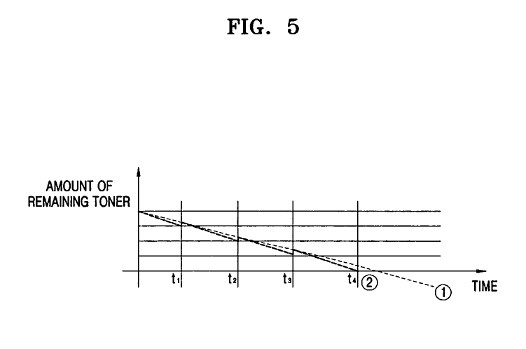

FIG. 4 is a block diagram of an embodiment of the toner remaining amount adjusting unit 160 illustrated in FIG. 2. Referring to FIG. 4, the toner remaining amount adjusting unit 160 includes a toner presence determining unit 200, a toner remaining amount determining unit 220, and a adjusting unit 240.

When receiving the light receiving result from one of the first to fourth light receiving units 150, 152, 154, and 156, the toner presence determining unit 200 determines that the cell corresponding to the light receiving result from one of the first to fourth light receiving units 150, 152, 154, and 156 does not contain toner. For example, when receiving the light receiving result that the first light receiving unit 150 receives the light reflected by the first toner agitating unit 130 illustrated in FIG. 2, the toner presence determining unit 200 determines that the first cell 120 does not contain toner. Further, when receiving the light receiving result that the second light receiving unit 152 receives the light reflected by the second toner agitating unit 132, the toner presence determining unit 200 determines that no toner remains in the second cell 122. Also, when receiving the light receiving result that the third light receiving unit 154 receives the light reflected by the third toner agitating unit 134, the toner presence determining unit 200 determines that no toner remains in the third cell 124. Similarly, when receiving the light receiving result that the fourth light receiving unit receives the light reflected by the fourth toner agitating unit 136, the toner presence determining unit 200 determines that the fourth cell 126 contains no toner.

The toner remaining amount determining unit 220 determines the amount of toner remaining in the toner cartridge 110 in response to the determining result of the toner presence determining unit 200. For example, when receiving the result that the first cell 120 contains no toner from the toner presence determining unit 220, the toner remaining amount determining unit 220 determines that about 75 percent of the toner remains in the toner cartridge 110. This is because the first cell 120 has contained 25 percent of the toner. Further, when receiving the result that no toner remained in the second cell 122 from the toner presence determining unit 200, the toner remaining amount determining unit 220 determines that about 50 percent of the toner remains in the toner cartridge 110. When no toner remains in the second cell 122, there is no toner remained in the first cell 120. Since no toner remains in the first and second cells 120 and 122, each containing 25 percent of the toner, about 50 percent of the toner remains in the toner cartridge 110. In addition, when receiving the result that the third cell 124 does not contain toner from the toner presence determining unit 200, the toner remaining amount determining unit 220 determines that 25 percent of the toner remained in the toner cartridge 110. When no toner remains in the third cell 124, no toner remains in the first and second cells 120 and 122. That is, since no toner remains in the first, second and third cells 120, 122, and 124, each containing about 25 percent of the toner, about 25 percent of the toner remains in the toner cartridge 110. When receiving the result that the fourth cell 126 contains no toner from the toner presence determining unit 200, the toner remaining amount determining unit 220 determines that no toner remains in the toner cartridge 110. When no toner remains in the fourth cell 126, no toner remained in the first, second and third cells 120, 122 and 124 as well. Since no toner remained in the first, second, third, and fourth cells 120, 122, 124, and 126, each containing about 25 percent of the toner, the toner remaining amount determining unit determines that there is no remaining toner.

The adjusting unit 240 compares the amount of remaining toner determined by the toner remaining amount determining unit 220 with the amount of remaining toner detected using a dot count method and adjusts the detected amount of remaining toner. More specifically, when receiving the determined amount of remaining toner from the toner remaining amount determining unit 220, the adjusting unit 240 compares the amount of remaining toner that has been previously detected using the dot count method with the determined amount of remaining toner. If the detected amount of remaining toner is not identical with the amount of remaining toner determined by the toner remaining amount determining unit 220, the adjusting unit 240 sets the determined amount of remaining toner as the amount of toner remained in the image forming apparatus.

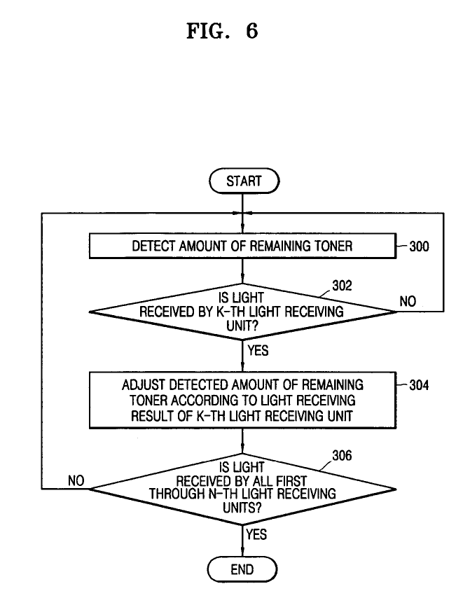

FIG. 5 is a graph for explaining errors that occur when the amount of remaining toner is adjusted according to an embodiment of the present invention. At a first time t1, the toner remaining amount adjusting unit 160 adjusts the amount of remaining toner upon receiving light from the first light receiving unit 150. At a second time t2, the toner remaining amount adjusting unit 160 adjusts the amount of remaining toner upon receiving light from the second light receiving unit 152. Further, at a third time t3, the toner remaining amount adjusting unit 160 adjusts the amount of remaining toner upon receiving light from the third light receiving unit 154. At a fourth time t4, the toner remaining amount adjusting unit 160 adjusts the amount of remaining toner upon receiving light from the fourth light receiving unit 156. As shown in FIG. 5, there is little difference between the actual amount of remaining toner \textcircled{1} and the amount of remaining toner \textcircled{2} adjusted by the toner remaining amount adjusting unit 160. This is because the toner remaining amount adjusting unit 160 adjusts the amount of remaining toner at first, second, third, and fourth times t1, t2, t3, and t4.

Although the device including the first through fourth cells 120, 122, 124, and 126, the first through fourth toner agitating units 130, 132, 134, and 136, the first through fourth light emitting units 140, 142, 144, and 146, and the first through fourth light receiving units 150, 152, 154, and 156 has been described above as an embodiment of the present invention, the number of the cells, the toner agitating units, the light emitting units, and the light receiving units is not limited to four, and the number of the units can vary.

FIG. 6 is a flowchart illustrating a method of adjusting the amount of remaining toner according to an embodiment of the present invention.

In operation 300, the amount of remaining toner is detected using a dot count method.

In operation 302, it is checked whether light is received by a k-th (‘k’ represents a natural number which is larger than 1 and smaller than ‘n’) light receiving unit of a first to n-th (‘n’ represents a positive integer larger than 1) light receiving units.

If the light is received by the k-th light receiving unit, the detected amount of remaining toner is adjusted according to the light receiving result in operation 304.

The detected amount of remaining toner is adjusted each time when the light receiving result from one of the first through n-th light receiving units receives light.

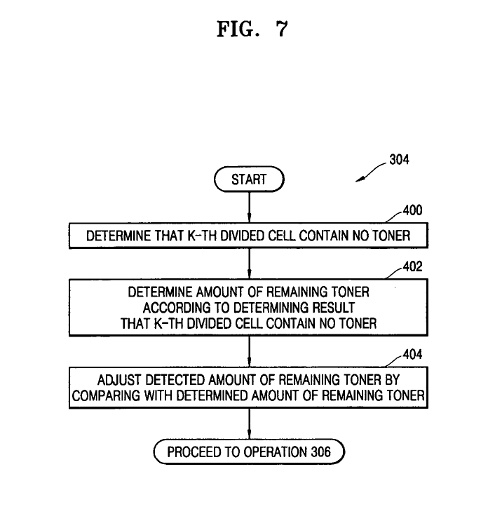

FIG. 7 is a flowchart illustrating in detail the operation 304 of FIG. 6.

When the result that the k-th light receiving unit receives the light from the k-th light receiving unit, it is determined that there is no toner remaining in a k-th cell of the first to n-th cells of a toner cartridge in operation 400. The result that the k-th light receiving unit receives the light implies that the k-th toner cell that has reflected the light to the k-th light receiving unit contains no toner. Therefore, when the light receiving result is received from the k-th light receiving unit, it is determined that the k-th cell contains no toner.

In operation 402, the amount of remaining toner is determined according to the determining result that the k-th cell contains no toner. For example, referring again to FIG. 2, in operation 402, when it is assumed that the k-th cell is the first cell 120 and the result that the first cell 120 contains no toner is received, it is determined that about 75 percent of the toner remains in the toner cartridge 110. Further, in operation 402, when it is assumed that the k-th cell is the second cell 122 and the result that the second cell 122 contains no toner is received, it is determined that about 50 percent of the toner remains in the toner cartridge 110. In operation 402, when it is assumed that the k-th cell is the third cell 124 and the result that the third cell 124 contains no toner is received, it is determined that about 25 percent of the toner remains in the toner cartridge 110. In operation 402, when it is assumed that the k-th cell is the fourth cell 126 and the result that the fourth cell 126 contains no toner is received, it is determined that the toner is exhausted.

In operation 404, the determined amount of remaining toner and the detected amount of remaining toner are compared, and then the detected amount of remaining toner is adjusted. The amount of remaining toner that has been detected using the dot count method is compared with the determined amount of remaining toner. If the amount of remaining toner that has been detected using the dot count method is not equal to the determined amount of remaining toner, the determined amount of remaining toner is set as the amount of toner remaining in the image forming apparatus.

Referring again to FIG. 6, after operation 304, it is checked whether all the first through n-th light receiving units receives the light in operation 306. If the first through n-th light receiving units do not receive light, the toner remains in the cells, and the procedure goes back to operation 300 and the above operations are repeated. However, if all the first through n-th light receiving units receive the light, no toner remains in the toner cartridge, and therefore the amount of remaining toner does not need adjustment and the operations are terminated.

According to the exemplary embodiments of the present invention as described above, a device and method for adjusting the amount of remaining toner can accurately measure the amount of toner consumption in an image forming apparatus.

In particular, the device and method according to the exemplary embodiments of the present invention adjust the measurement errors, which are generated when a conventional dot count method is used, through several steps, thereby obtaining accurate measured data.

Further, the device and method according to the exemplary embodiments of the present invention can inform the user continuously and accurately of the amount of remaining toner by combining signals successively obtained by a sensor and information about the amount of remaining toner successively obtained using the dot count method.

Accordingly, the device and method according to the exemplary embodiments of the present invention allow a user to determine the right time to replace consumables and the state of how much the consumables are used.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A device which adjusts the amount of remaining toner, the device comprising:
first through n-th light emitting units, each of which emits light;
first through n-th toner agitating units which are respectively formed in first through n-th cells of a toner cartridge and respectively reflect the light emitted from the first through n-th light emitting units;
first through n-th light receiving units which receive the light reflected by the first through n-th toner agitating units, respectively; and
a toner remaining amount adjusting unit which adjusts a detected amount of remaining toner according to the light receiving results of the first through n-th light receiving units.

2. The device of claim 1, wherein each of the first through n-th light emitting units uses a light emitting diode.

3. The device of claim 1, wherein each of the first through n-th light receiving units uses a light receiving diode.

4. The device of claim 1, wherein the first through n-th toner agitating units are made of either polyethylene film or polyethylene terephthalate.

5. The device of claim 1, the toner cartridge is made of a material configured to penetrate the light reflected by the first through n-th toner agitating units.

6. The device of claim 1, the toner remaining amount adjusting unit comprises:
a toner presence determining unit which determines that a k-th cell of the first through n-th cells contains no toner when receiving a result that a k-th light receiving cell receives light;
a toner remaining amount determining unit which determines the amount of remaining toner in response to the determining result of the toner presence determining unit; and
an adjusting unit which adjusts the detected amount of remaining toner by comparing with the determined amount of remaining toner.

7. The device of claim 6, wherein the toner remaining amount adjusting unit adjusts the detected amount of remaining toner each time when receiving the light receiving result from one of the first through n-th light receiving units receives light.

8. The device of claim 1, wherein the toner remaining amount adjusting unit adjusts the amount of remaining toner that has been detected using a dot count method.

9. A method of adjusting the amount of remaining toner, the method comprising:
detecting the amount of remaining toner;
checking whether a k-th light receiving unit of first through n-th light receiving units receives light;
adjusting the detected amount of remaining toner according to the light receiving result of the k-th light receiving unit when the k-th receiving unit receives light; and
checking whether all the first through n-th light receiving units receive light.

10. The method of claim 9, wherein, the step of detecting the amount of remaining toner, the amount of remaining toner is detected using a dot count method.

11. The method of claim 9, wherein the adjusting of the detected amount of remaining toner comprises:
determining that a k-th cell of first through n-th cells of a toner cartridge contains no toner when the light receiving result is received from the k-th light receiving unit;
determining the amount of remaining toner according to the determining result that the k-th cell contains no toner; and
adjusting the detected amount of remaining toner by comparing it with the determined amount of remaining toner.

12. The device of claim 11, wherein, in the adjusting the detected amount of remaining toner, the detected amount of remaining toner is adjusted each time when the light receiving result is received from one of the first through n-th light receiving units.

13. The device of claim 9, wherein ‘k’ represents an integer that is larger than 1 and not more than ‘n’ which is a integer larger than 1.

14. A method of adjusting the amount of remaining toner, the method comprising:
detecting the amount of remaining toner using a dot count method;
determining whether a k-th light receiving unit of first through n-th light receiving units receives light;
adjusting the detected amount of remaining toner according to the light receiving result of the k-th light receiving unit when the k-th receiving unit receives light; and
determining whether all the first through n-th light receiving units receive light.

15. The method of claim 14, wherein, in the detecting of the amount of remaining toner, the amount of remaining toner is detected using a dot count method.

16. The method of claim 14, wherein the adjusting of the detected amount of remaining toner comprises:
determining that a k-th cell of first through n-th cells of a toner cartridge contains no toner when the light receiving result is received from the k-th light receiving unit;
determining the amount of remaining toner according to the determining result that the k-th cell contains no toner; and
adjusting the detected amount of remaining toner by comparing it with the determined amount of remaining toner.

17. The device of claim 14, wherein, in the adjusting the detected amount of remaining toner, the detected amount of remaining toner is adjusted each time when the light receiving result is received from one of the first through n-th light receiving units.

18. The device of claim 14, wherein ‘k’ represents an integer that is larger than 1 and not more than ‘n’ which is a integer larger than 1.
